(19) United States
(12) Patent Application Publication
(10) Pub. No.: US 2023/0351470 A1
(43) Pub. Date: Nov. 2, 2023

(54) METHODS, SYSTEMS, APPARATUSES, AND DEVICES FOR RECOMMENDING GIFT CARDS FOR MAXIMIZING REWARDS ON PURCHASING PRODUCTS USING THE GIFT CARDS

(71) Applicant: chukwuezugo nwosu, kirkland, WA (US)

(72) Inventor: chukwuezugo nwosu, kirkland, WA (US)

(21) Appl. No.: 17/731,460

(22) Filed: Apr. 28, 2022

(51) Int. Cl. G06Q 30/06; G06Q 20/34; G06Q 30/02

(52) U.S. Cl. CPC G06Q 30/0631; G06Q 20/3433; G06Q 30/0226; G06Q 30/0211

(57) ABSTRACT

Disclosed herein is a method for recommending gift cards for maximizing rewards on purchasing products using the gift cards. Accordingly, the method may include receiving a purchase request from a user device associated with a user, identifying a merchant from merchants based on the purchase request, identifying a store associated with the merchant, receiving a gift card data associated with the gift cards from a store device associated with the store, analyzing the gift card data using a machine learning model, identifying a gift card from the gift cards based on the analyzing of the gift card data, generating a recommendation for the gift cards based on the identifying of the gift card, transmitting the recommendation to the user device, and storing the recommendation.

### FIELD OF THE INVENTION

Generally, the present disclosure relates to the field of data processing. More specifically, the present disclosure relates to methods, systems, apparatuses, and devices for recommending gift cards for maximizing rewards on purchasing products using the gift cards.

### BACKGROUND OF THE INVENTION

The field of data processing is technologically important to several industries, business organizations, and/or individuals. In particular, the use of data processing is prevalent for recommending gift cards on purchasing products.

Generally, shoppers are inundated with multiple opportunities to save on the cost of everyday purchases i.e. in-store vs. online discounts, flash sales, coupons, bulk discounts, temporary credit card offers, rewards discounts, airline rewards, gas rewards, etc. This dizzying array of options is further complicated by a range of conflicting requirements, rules, and restrictions i.e. geographic restrictions, minimum spend requirements, expiration, rules for combining offers, etc. It's impossible to leverage all available savings for each purchase. Currently, this process is done manually and customers typically focus on a single or few savings opportunities at any one time. In order to take advantage of these savings opportunities, a shopper has to manually find all offers that apply to each purchase, understand the rules and restrictions of each offer, and determine and use the best offer(s) for each purchase before buying anything. Manually repeating these steps for each purchase is difficult, painful, and time-consuming. It's no surprise that many shoppers (or customers) don't bother and leave a lot of money on the table.

Therefore, there is a need for improved methods, systems, apparatuses, and devices for recommending gift cards for maximizing rewards on purchasing products that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for recommending gift cards for maximizing rewards on purchasing products using the gift cards, in accordance with some embodiments. Accordingly, the method may include receiving, using a communication device, a purchase request from at least one user device associated with at least one user. Further, the purchase request may include a product data associated with at least one product. Further, the method may include identifying, using the processing device, at least one merchant from a plurality of merchants based on the purchase request. Further, the at least one merchant sells the at least one product. Further, the method may include identifying, using the processing device, at least one store associated with the at least one merchant based on the identifying of the at least one merchant. Further, the at least one store provides a plurality of gift cards for purchasing the at least one product from the at least one merchant. Further, the method may include receiving, using the communication device, a plurality of gift card data associated with the plurality of gift cards from at least one store device associated with the at least one store. Further, the plurality of gift card data may include a plurality of rewards available to the at least one user corresponding to a plurality of criteria for availing the plurality of rewards. Further, the method may include analyzing, using the processing device, the plurality of gift card data using at least one machine learning model. Further, the method may include identifying, using the processing device, at least one gift card from the plurality of gift cards based on the analyzing of the plurality of gift card data. Further, a value of at least one reward associated with the at least one gift card may be maximum in relation to the plurality of rewards associated with the plurality of gift cards corresponding to at least one criterion of the plurality of criteria for availing the at least one reward. Further, the method may include generating, using the processing device, at least one recommendation for the plurality of gift cards may be based on the identifying of the at least one gift card. Further, the method may include transmitting, using the communication device, the at least one recommendation to the at least one user device. Further, the method may include storing, using a storage device, the at least one recommendation.

Further disclosed herein is a system for recommending gift cards for maximizing rewards on purchasing products using the gift cards, in accordance with some embodiments. Accordingly, the system may include a communication device configured for receiving a purchase request from at least one user device associated with at least one user. Further, the purchase request may include a product data associated with at least one product. Further, the communication device may be configured for receiving a plurality of gift card data associated with a plurality of gift cards from at least one store device associated with at least one store. Further, the plurality of gift card data may include a plurality of rewards available to the at least one user corresponding to a plurality of criteria for availing the plurality of rewards. Further, the communication device may be configured for transmitting at least one recommendation to the at least one user device. Further, the system may include a processing device communicatively coupled with the communication device. Further, the processing device may be configured for identifying at least one merchant from a plurality of merchants based on the purchase request. Further, the at least one merchant sells the at least one product. Further, the processing device may be configured for identifying the at least one store associated with the at least one merchant based on the identifying of the at least one merchant. Further, the at least one store provides the plurality of gift cards for purchasing the at least one product from the at least one merchant. Further, the processing device may be configured for analyzing the plurality of gift card data using at least one machine learning model. Further, the processing device may be configured for identifying at least one gift card from the plurality of gift cards based on the analyzing of the plurality of gift card data. Further, a value of at least one reward associated with the at least one gift card may be maximum in relation to the plurality of rewards associated with the plurality of gift cards corresponding to at least one criterion of the plurality of criteria for availing the at least one reward. Further, the processing device may be configured for generating the at least one recommendation for the plurality of gift cards based on the identifying of the at least one gift card. Further, the system may include a storage device communicatively coupled with the processing device. Further, the storage device may be configured for storing the at least one recommendation.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flow diagram of a method for recommending gift cards for maximizing rewards on purchasing products using the gift cards, in accordance with some embodiments.

FIG. 3 is a flow chart of a method for recommending gift cards for maximizing rewards on purchasing products using the gift cards, in accordance with some embodiments.

FIG. 4 is a flow chart of a method for recommending gift cards for maximizing rewards on purchasing products using the gift cards, in accordance with some embodiments.

FIG. 5 is a flow chart of a method for recommending gift cards for maximizing rewards on purchasing products using the gift cards, in accordance with some embodiments.

FIG. 6 is a block diagram of a system for recommending gift cards for maximizing rewards on purchasing products using the gift cards, in accordance with some embodiments.

FIG. 7 is a block diagram of the system for recommending gift cards for maximizing rewards on purchasing products using the gift cards, in accordance with some embodiments.

FIG. 8 is a block diagram of the system for recommending gift cards for maximizing rewards on purchasing products using the gift cards, in accordance with some embodiments.

FIG. 9 is a block diagram of the system for recommending gift cards for maximizing rewards on purchasing products using the gift cards, in accordance with some embodiments.

FIG. 10 is a block diagram of the system for recommending gift cards for maximizing rewards

FIG. 11 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for recommending gift cards for maximizing rewards on purchasing products using the gift cards, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), and a biometric sensor (e.g. a fingerprint sensor) associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for recommending gift cards for maximizing rewards on purchasing products using the gift cards. Further, the disclosed system may be associated with a software platform (such as a software application and website). Further, the software platform may include a payment app that uses artificial intelligence (AI) to analyze all available discounts and savings opportunities just before every single purchase and determine the best way to save on a cost of a purchase. Further, SaveAI, an exemplary embodiment of the disclosed system herein, may allow a user to get more bang for his buck for everyday purchases. Further, the SaveAI may eliminate this complexity by using AI to analyze all available discounts and savings opportunities, identify opportunities to combine multiple offers, and recommend the best way to save. For the MVP, the disclosed system may focus on the grocery store gas rewards program and using a best credit card for each purchase. Further, the disclosed system may add other savings opportunities.

Further, customers may shop at grocery stores (Safeway, Albertsons, etc.) and other merchants (i.e. BestBuy, Delta Airline, etc.). Americans spend approx. $100 billion on gift cards each year from a myriad of physical and online businesses. Several grocery stores have a gas rewards program that offers discounts on gas in return for purchases at the grocery store.

Further, in an instance, a shopper may be using BestBuy™ (merchant) and Safeway™ (grocery store). Further, the customer wants to buy a 50 inch TV from BestBuy™ at a cost of $1000.00. Instead of using cash or a credit card to purchase BestBuy™, the customer may buy $1000.00 worth of BestBuy™ gift cards from the Safeway™ and use the gift card to buy the TV from BestBuy™. By purchasing the gift card from Safeway™, the customer may get the equivalent gas rewards points associated with spending $1000 at Safeway™. Further, at Safeway™, the customers earn 2 points per $1 spent on select gift cards. Excluded are Albertsons Companies Gift Cards, Chevron, Texaco, Shell, American Express®, MasterCard®, Visa®, NetSpend®, PayPower™, Green Dot®, Green Dot® Reload and Reloadit, Univision Mastercard® Prepaid Card, and T-Mobile® Prepaid Debit Card. Further, 100 points may be equal to 100 per gallon Gas Reward (gallon restrictions may apply). This means that a $1000.00=2000 points=$2.00 per gallon in savings at Safeway's gas station. Further, in an instance, the customers' car has 15 gallons, the customer may be able to save $2.00 per gallon*15 gallons=$30.00. Further, the customer may apply the rewards to get cash discounts on groceries instead of gas rewards. Further, in an instance, the credit card used by the customer may offer 2% cashback rewards for grocery purchases. This means that the customer can also get 2%*$1000.00=$20.00 back in savings. So, for this single purchase, the customer may save $30.00 (gas savings)+$20.00 (credit card cashback reward)=$50.00.

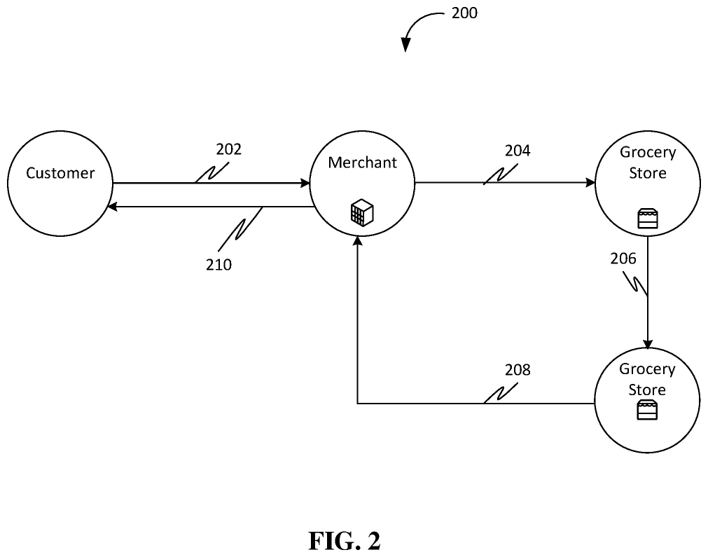

Further, now imagine the potential savings if this is done for each daily purchase. Further, the SaveAI may leverage machine learning to analyze all valid savings opportunities, automate the process, and select the best savings opportunity each time you swipe your credit or debit card. At the point of sale, the SaveAI may orchestrate and facilitate this process across the following participants—customer, merchant, and grocery stores as shown FIG. 2.

Further, the disclosed system may leverage AI to select and automate the process of determining and selecting the best rewards for each purchase.

Further, the disclosed system may be configured to find and apply savings opportunities before making a purchase. Further, the disclosed system may allow the user to make just in time savings. Further, the disclosed system may allow the user to buy a gift card and use the use gift card to make the purchase. Further, the disclosed system may be configured for combining different savings opportunities for each purchase. Further, the disclosed system may be configured for analyzing rules for each savings opportunity to determine valid opportunities or which opportunities can be combined. Further, the disclosed system may include a payment system that automatically applies coupons or discounts for each purchase.

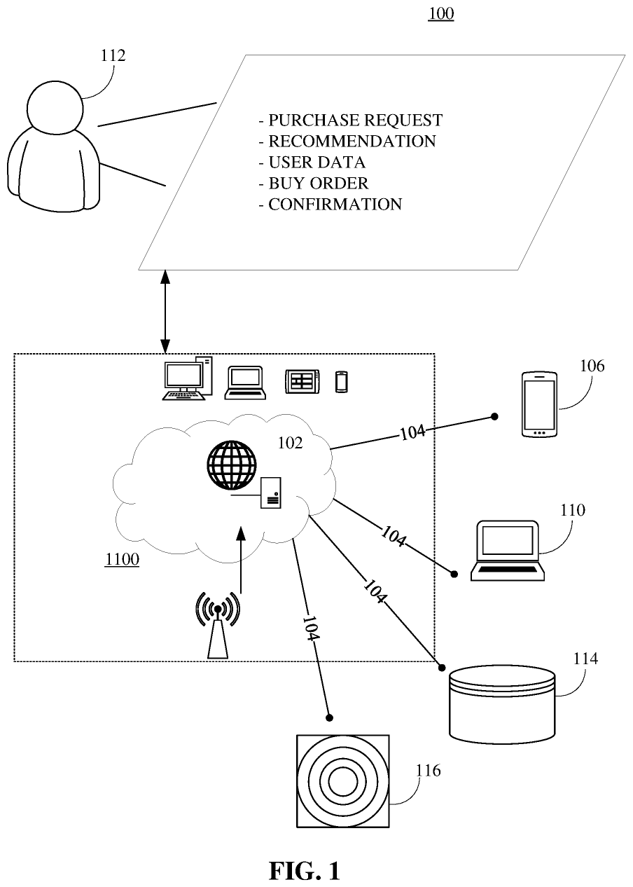

FIG. 1 is an illustration of an online platform 100 consistent with various embodiments of the present disclosure. By way of non-limiting example, the online platform 100 for recommending gift cards for maximizing rewards on purchasing products using the gift cards may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1100.

FIG. 2 is a flow diagram of a method 200 for recommending gift cards for maximizing rewards on purchasing products using the gift cards, in accordance with some embodiments. Accordingly, at 202, the method 200 may include a customer opening a SaveAI app, associated with the disclosed system, to make a purchase at a merchant. Further, at 204, the method 200 may include the SaveAI identifying all grocery stores that gift cards for the merchant. Further, at 206, the method 200 may include the customer, using the SaveAI app, buying a card (or gift card) from the grocery store that offers best savings using an appropriate customer credit or debit card (i.e. offers the best grocery rewards). Further, at 208, the method 200 may include the customer, using the SaveAI app, purchasing the product from the merchant using the gift card that was purchased from the grocery store. Further, at 210, the method 200 may include the SaveAI app assigning all rewards associated with the gift card purchase to the customer.

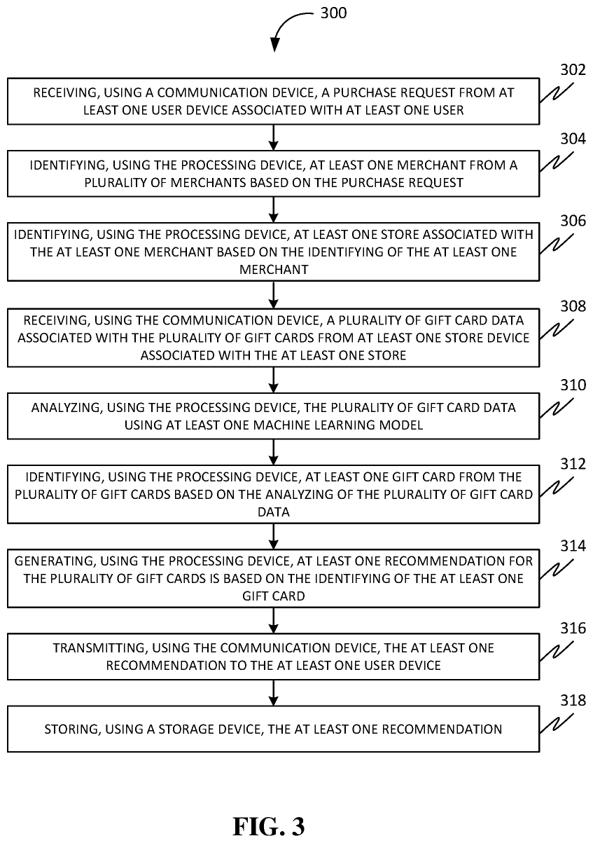

FIG. 3 is a flow chart of a method 300 for recommending gift cards for maximizing rewards on purchasing products using the gift cards, in accordance with some embodiments. Accordingly, at 302, the method 300 may include receiving, using a communication device, a purchase request from at least one user device (such as at least one user device 702) associated with at least one user. Further, the purchase request may include a product data associated with at least one product. Further, the product data may include a product name, a product color, a product specification, a product price, etc. Further, at 304, the method 300 may include identifying, using the processing device, at least one merchant from a plurality of merchants based on the purchase request. Further, the at least one merchant sells the at least one product. Further, at 306, the method 300 may include identifying, using the processing device, at least one store associated with the at least one merchant based on the identifying of the at least one merchant. Further, the at least one store provides a plurality of gift cards for purchasing the at least one product from the at least one merchant. Further, the plurality of gift cards may include online discount cards, flash sale cards, coupons, bulk discount cards, etc. Further, at 308, the method 300 may include receiving, using the communication device, a plurality of gift card data associated with the plurality of gift cards from at least one store device (such as at least one store device 704) associated with the at least one store. Further, the plurality of gift card data may include a plurality of rewards available to the at least one user corresponding to a plurality of criteria for availing the plurality of rewards. Further, the plurality of rewards may include temporary credit card offers, bulk discounts, rewards discounts, airline rewards, gas rewards, etc. Further, at 310, the method 300 may include analyzing, using the processing device, the plurality of gift card data using at least one machine learning model. Further, at 312, the method 300 may include identifying, using the processing device, at least one gift card from the plurality of gift cards based on the analyzing of the plurality of gift card data. Further, a value of at least one reward associated with the at least one gift card may be maximum in relation to the plurality of rewards associated with the plurality of gift cards corresponding to at least one criterion of the plurality of criteria for availing the at least one reward. Further, the at least one criterion may include geographic restrictions, minimum spend requirements, expiration period, rules for combining offers, etc. Further, at 314, the method 300 may include generating, using the processing device, at least one recommendation for the plurality of gift cards may be based on the identifying of the at least one gift card. Further, at 316, the method 300 may include transmitting, using the communication device, the at least one recommendation to the at least one user device. Further, at 318, the method 300 may include storing, using a storage device, the at least one recommendation.

Further, in some embodiments, the method 300 may include determining, using the processing device, a compatibility between two or more of the plurality of criteria for the availing of two or more of the plurality of rewards associated with the two or more of the plurality of gift cards. Further, the compatibility corresponds to a combining capacity of the two or more of the plurality of gift cards based on a similarity between two or more of the plurality of criteria associated with the two or more of the plurality of gift cards. Further, the at least one gift card may include two or more gift cards. Further, the identifying of the at least one gift card may include identifying the two or more gift cards based on the determining of the compatibility. Further, the value of the two or more of the plurality of rewards associated with the two or more gift cards may be maximum in relation to the plurality of rewards associated with the plurality of gift cards corresponding to the compatibility between two or more of the plurality of criteria. Further, the generating of the at least one recommendation for the gift cards may be based on the identifying of the at one or more gift cards.

Further, in some embodiments, the user data may include a location data associated with the at least one user. Further, the location data may include a location of the at least one user. Further, the at least one user constraint may include the location. Further, the plurality of criteria may include one or more geographical location restrictions. Further, the analyzing of the user data may include analyzing the location data using the at least one machine learning model. Further, the fulfillment may include a location fulfillment. Further, the determining of the fulfillment may include determining the location fulfillment of each of the one or more geographical location restrictions by the location. Further, the identifying of the at least one criterion ideal to the at least one user may be based on the determining of the location fulfillment.

Further, in some embodiments, the at least one user device may include at least one sensor (such as at least one sensor 802). Further, the at least one sensor may include a GPS receiver, a GLONASS receiver, an indoor location sensor, etc. Further, the at least one sensor may be configured for generating the location data based on detecting the location of the at least one user. Further, the user data may include the location data.

Further, in some embodiments, the user data may include a user preference data associated with the at least one user. Further, the user preference data may include at least one preference of the at least one user associated with the plurality of rewards. Further, the at least one user constraint may include the at least one preference. Further, the at least one preference may include a reward preference corresponding to the plurality of rewards. Further, the analyzing of the user data may include analyzing the user preference data using the at least one machine learning model. Further, the fulfillment may include a preference fulfillment. Further, the determining of the fulfillment may include determining of the preference fulfillment of each of the plurality of requirements by the at least one preference. Further, the identifying of the at least one criterion ideal to the at least one user may be based on the determining of the preference fulfillment. Further, in an instance, the reward preference may include a gas reward preference corresponding to a gas reward. Further, the gas reward preference may indicate that the at least one user may want to avail the gas reward based on the purchasing of the at least one product. Further, in another instance, the reward preference may include a grocery store reward preference corresponding to a grocery store reward. Further, the grocery store reward preference may indicate that the at least one user may want to avail the grocery store reward for purchasing groceries from a grocery store.

Further, in some embodiments, the user data may include a user payment data associated with the at least one user. Further, the user payment data may include at least one payment option of the at least one user. Further, the user payment option may include NEFT, IMPS, UPI transfer, etc. Further, the at least one user constraint may include the at least one payment option. Further, the analyzing of the user data may include analyzing the user payment data using the at least one machine learning model. Further, the fulfillment may include a payment option fulfillment. Further, the determining of the fulfillment may include determining the payment option fulfillment of each of the plurality of criteria by the at least one payment option. Further, the identifying of the at least one criterion ideal to the at least one user may be based on the determining of the payment option fulfillment.

Further, in some embodiments, the at least one user device may include at least one input device (such as at least one input device 902). Further, the at least one input device may be configured for generating the at least one input data based on scanning at least one physical payment card associated with the at least one user. Further, the user payment data may include the at least one input data. Further, the at least one payment option may include the at least one physical payment card. Further, the at least one physical payment card may include a debit card and a credit card.

Further, in some embodiments, the method 300 may include receiving, using the communication device, a first feedback corresponding to the purchasing of the at least one product from the at least one user device. Further, the method 300 may include analyzing, using the processing device, the first feedback. Further, the method 300 may include generating, using the processing device, a merchant rating associated with the at least one merchant based on the analyzing of the first feedback. Further, the merchant rating reflects a quality standard of the at least one product sold by the at least one merchant. Further, the merchant rating may include a star rating. Further, the identifying of the at least one merchant may be based on the merchant rating.

Further, in some embodiments, the method 300 may include receiving, using the communication device, a second feedback corresponding to the at least one gift card from the at least one user device. Further, the method 300 may include analyzing, using the processing device, the second feedback. Further, the method 300 may include generating, using the processing device, a store gift card rating associated with the at least one gift card based on the analyzing of the second feedback. Further, the store gift card rating reflects an authenticity of the at least one gift card. Further, the identifying of the at least one gift card may be based on the store gift card rating.

Further, in some embodiments, the method 300 may include determining, using the processing device, a purchase time period corresponding to the purchasing of the at least one product based on the analyzing of the purchase request. Further, the method 300 may include analyzing, using the processing device, the purchase time period and one or more gift card data. Further, the method 300 may include generating, using the processing device, a reminder for the purchasing of the at least one product based on the analyzing of the purchase time period and the one or more gift card data. Further, the method 300 may include transmitting, using the communication device, the reminder to the at least one user device. Further, the method 300 may include receiving, using the communication device, an approval corresponding to the reminder from the at least one user device. Further, the identifying of the at least gift card may be based on the approval.

Further, in some embodiments, the at least one merchant may include a first merchant and a second merchant. Further, the plurality of gift card data comprise a first gift card data associated with a first gift card applicable to the first merchant and a second gift card data associated with a second gift card applicable to the second merchant. Further, the method 300 may include receiving, using the communication device, a first delivery data from at least one first merchant device. Further, the method 300 may include receiving, using the communication device, a second delivery data from at least one second merchant device. Further, the method 300 may include analyzing, using the processing device, the first delivery data, the second delivery data, the purchase request, and the user data. Further, the method 300 may include determining, using the processing device, a first delivery plan associated with the first merchant and a second delivery plan associated with the second merchant based on the analyzing of the first delivery data, the second delivery data, the purchase request, and the user data. Further, the method 300 may include analyzing, using the processing device, the first delivery plan, the first gift card data, the second delivery plan, and the second gift card data. Further, the method 300 may include determining, using the processing device, a first effective price associated with the purchasing of the at least one product from the first merchant. Further, the method 300 may include comparing, using the processing device, the first effective price and the second effective price. Further, the method 300 may include selecting, using the processing device, one of the first gift card and the second gift card based on the comparing. Further, the identifying of the at least one gift card may be based on the selecting of one of the first gift card and the second gift card.

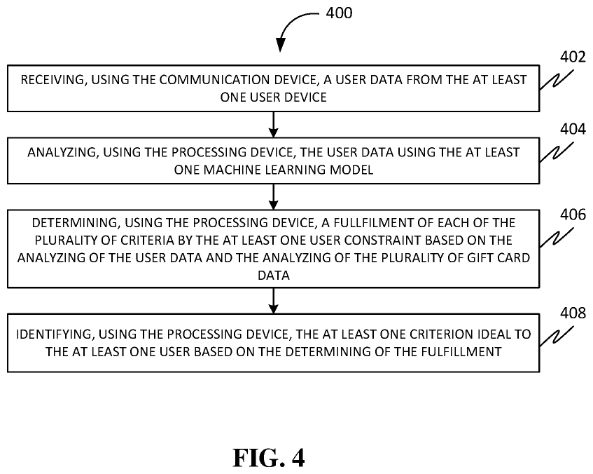

FIG. 4 is a flow chart of a method 400 for recommending gift cards for maximizing rewards on purchasing products using the gift cards, in accordance with some embodiments. Accordingly, at 402, the method 400 may include receiving, using the communication device, a user data from the at least one user device. Further, the user data may include at least one user constraint. Further, at 404, the method 400 may include analyzing, using the processing device, the user data using the at least one machine learning model. Further, at 406, the method 400 may include determining, using the processing device, a fullfilment of each of the plurality of criteria by the at least one user constraint based on the analyzing of the user data and the analyzing of the plurality of gift card data. Further, at 408, the method 400 may include identifying, using the processing device, the at least one criterion ideal to the at least one user based on the determining of the fulfillment. Further, the identifying of the at least one gift card may be based on the identifying of the at least one criterion.

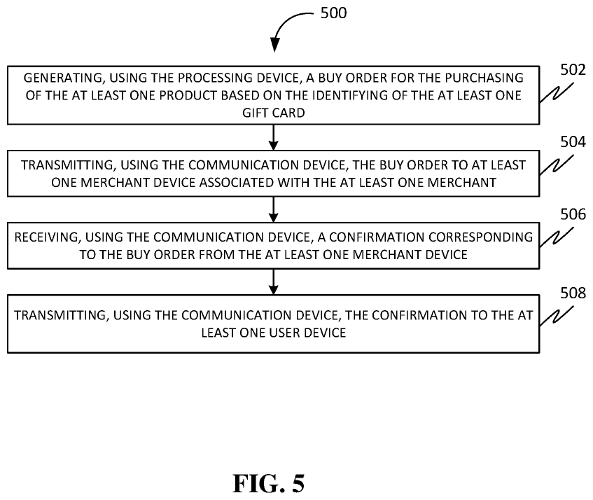

FIG. 5 is a flow chart of a method 500 for recommending gift cards for maximizing rewards on purchasing products using the gift cards, in accordance with some embodiments. Accordingly, at 502, the method 500 may include generating, using the processing device, a buy order for the purchasing of the at least one product based on the identifying of the at least one gift card. Further, at 504, the method 500 may include transmitting, using the communication device, the buy order to at least one merchant device (such as at least one merchant device 1002) associated with the at least one merchant. Further, at 506, the method 500 may include receiving, using the communication device, a confirmation corresponding to the buy order from the at least one merchant device. Further, at 508, the method 500 may include transmitting, using the communication device, the confirmation to the at least one user device.

Further, in some embodiments, the method 500 may include storing, using the storage device, at least one of the confirmation, the buy order, and the purchase request in a distributed ledger.

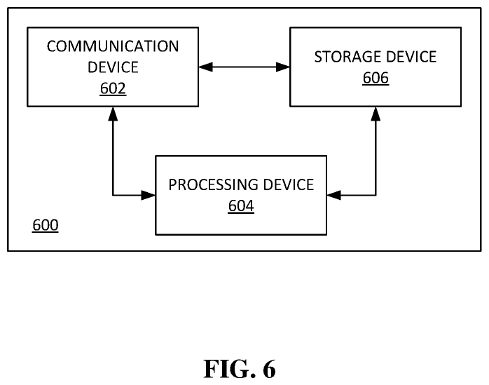

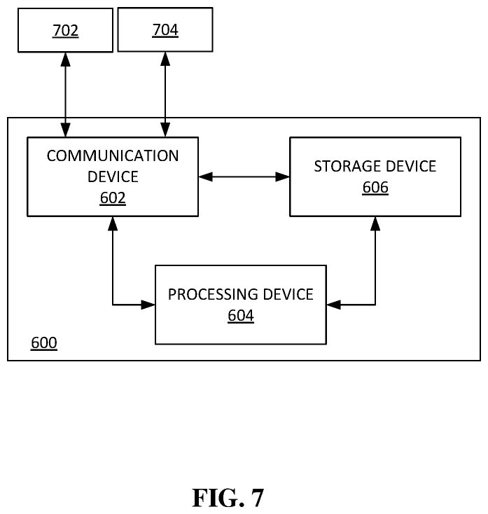

FIG. 6 is a block diagram of a system 600 for recommending gift cards for maximizing rewards on purchasing products using the gift cards, in accordance with some embodiments. Accordingly, the system 600 may include a communication device 602 configured for receiving a purchase request from at least one user device 702 (as shown in FIG. 7) associated with at least one user. Further, the purchase request may include a product data associated with at least one product. Further, the communication device 602 may be configured for receiving a plurality of gift card data associated with a plurality of gift cards from at least one store device 704 (as shown in FIG. 7) associated with at least one store. Further, the plurality of gift card data may include a plurality of rewards available to the at least one user corresponding to a plurality of criteria for availing the plurality of rewards. Further, the communication device 602 may be configured for transmitting at least one recommendation to the at least one user device 702.

Further, the system 600 may include a processing device 604 communicatively coupled with the communication device 602. Further, the processing device 604 may be configured for identifying at least one merchant from a plurality of merchants based on the purchase request. Further, the at least one merchant sells the at least one product. Further, the processing device 604 may be configured for identifying the at least one store associated with the at least one merchant based on the identifying of the at least one merchant. Further, the at least one store provides the plurality of gift cards for purchasing the at least one product from the at least one merchant. Further, the processing device 604 may be configured for analyzing the plurality of gift card data using at least one machine learning model. Further, the processing device 604 may be configured for identifying at least one gift card from the plurality of gift cards based on the analyzing of the plurality of gift card data. Further, a value of at least one reward associated with the at least one gift card may be maximum in relation to the plurality of rewards associated with the plurality of gift cards corresponding to at least one criterion of the plurality of criteria for availing the at least one reward. Further, the processing device 604 may be configured for generating the at least one recommendation for the plurality of gift cards based on the identifying of the at least one gift card.

Further, the system 600 may include a storage device 606 communicatively coupled with the processing device 604. Further, the storage device 606 may be configured for storing the at least one recommendation.

Further, in some embodiments, the communication device 602 may be configured for receiving a user data from the at least one user device 702. Further, the user data may include at least one user constraint. Further, the processing device 604 may be configured for analyzing the user data using the at least one machine learning model. Further, the processing device 604 may be configured for determining a fullfilment of each of the plurality of criteria by the at least one user constraint based on the analyzing of the user data and the analyzing of the plurality of gift card data. Further, the processing device 604 may be configured for identifying the at least one criterion ideal to the at least one user based on the determining of the fulfillment. Further, the identifying of the at least one gift card f may be based on the identifying of the at least one criterion.

Further, in some embodiments, the user data may include a location data associated with the at least one user. Further, the location data may include a location of the at least one user. Further, the at least one user constraint may include the location. Further, the plurality of criteria may include one or more geographical location restrictions. Further, the analyzing of the user data may include analyzing the location data using the at least one machine learning model. Further, the fulfillment may include a location fulfillment. Further, the determining of the fulfillment may include determining the location fulfillment of each of the one or more geographical location restrictions by the location. Further, the identifying of the at least one criterion ideal to the at least one user may be based on the determining of the location fulfillment.

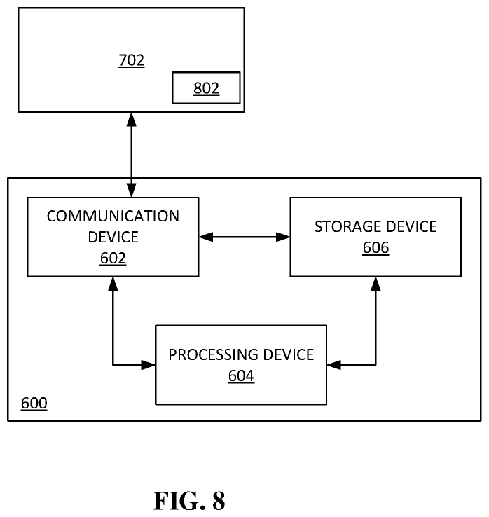

Further, in some embodiments, the at least one user device 702 may include at least one sensor 802 (as shown in FIG. 8). Further, the at least one sensor 802 may be configured for generating the location data based on detecting the location of the at least one user. Further, the user data may include the location data.

Further, in some embodiments, the user data may include a user preference data associated with the at least one user. Further, the user preference data may include at least one preference of the at least one user associated with the plurality of rewards. Further, the at least one user constraint may include the at least one preference. Further, the analyzing of the user data may include analyzing the user preference data using the at least one machine learning model. Further, the fulfillment may include a preference fulfillment. Further, the determining of the fulfillment may include determining of the preference fulfillment of each of the plurality of requirements by the at least one preference. Further, the identifying of the at least one criterion ideal to the at least one user may be based on the determining of the preference fulfillment.

Further, in some embodiments, the user data may include a user payment data associated with the at least one user. Further, the user payment data may include at least one payment option of the at least one user. Further, the at least one user constraint may include the at least one payment option. Further, the analyzing of the user data may include analyzing the user payment data using the at least one machine learning model. Further, the fulfillment may include a payment option fulfillment. Further, the determining of the fulfillment may include determining the payment option fulfillment of each of the plurality of criteria by the at least one payment option. Further, the identifying of the at least one criterion ideal to the at least one user may be based on the determining of the payment option fulfillment.

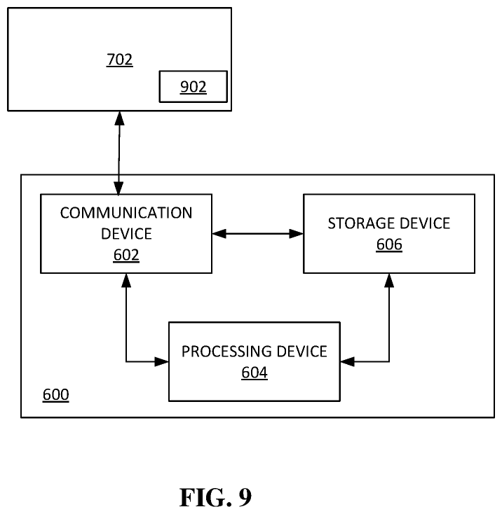

Further, in some embodiments, the at least one user device 702 may include at least one input device 902 (as shown in FIG. 9). Further, the at least one input device 902 may be configured for generating the at least one input data based on scanning at least one physical payment card associated with the at least one user. Further, the user payment data may include the at least one input data. Further, the at least one payment option may include the at least one physical payment card.

Further, in some embodiments, the processing device 604 may be configured for determining a compatibility between two or more of the plurality of criteria for the availing of two or more of the plurality of rewards associated with the two or more of the plurality of gift cards. Further, the at least one gift card may include two or more gift cards. Further, the identifying of the at least one gift card may include identifying the two or more gift cards based on the determining of the compatibility. Further, the value of the two or more of the plurality of rewards associated with the two or more gift cards may be maximum in relation to the plurality of rewards associated with the plurality of gift cards corresponding to the compatibility between two or more of the plurality of criteria. Further, the generating of the at least one recommendation for the gift cards may be based on the identifying of the at one or more gift cards.

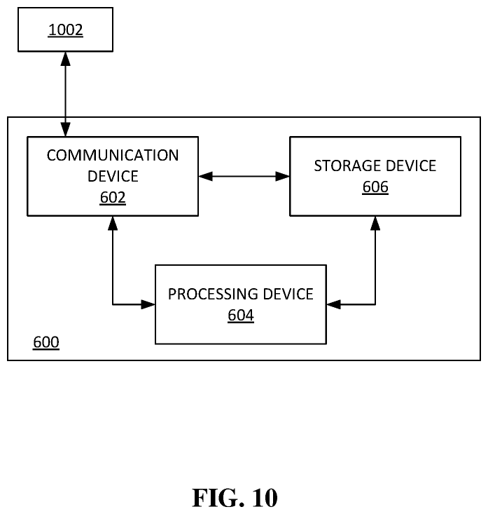

Further, in some embodiments, the processing device 604 may be configured for generating a buy order for the purchasing of the at least one product based on the identifying of the at least one gift card. Further, the communication device 602 may be configured for transmitting the buy order to at least one merchant device 1002 (as shown in FIG. 10) associated with the at least one merchant. Further, the communication device 602 may be configured for receiving a confirmation corresponding to the buy order from the at least one merchant device 1002. Further, the communication device 602 may be configured for transmitting the confirmation to the at least one user device 702.

Further, in some embodiments, the storage device 606 may be configured for storing at least one of the confirmation, the buy order, and the purchase request in a distributed ledger.

FIG. 7 is a block diagram of the system 600 for recommending gift cards for maximizing rewards on purchasing products using the gift cards, in accordance with some embodiments.

FIG. 8 is a block diagram of the system 600 for recommending gift cards for maximizing rewards on purchasing products using the gift cards, in accordance with some embodiments.

FIG. 9 is a block diagram of the system 600 for recommending gift cards for maximizing rewards on purchasing products using the gift cards, in accordance with some embodiments.

FIG. 10 is a block diagram of the system 600 for recommending gift cards for maximizing rewards on purchasing products using the gift cards, in accordance with some embodiments.

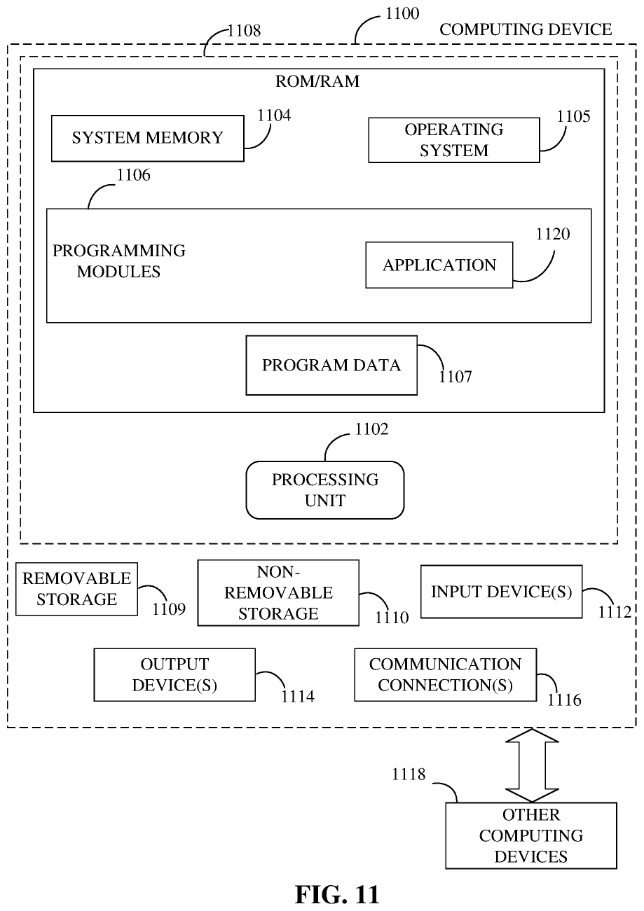

With reference to FIG. 11, a system consistent with an embodiment of the disclosure may include a computing device or cloud service, such as computing device 1100. In a basic configuration, computing device 1100 may include at least one processing unit 1102 and a system memory 1104. Depending on the configuration and type of computing device, system memory 1104 may comprise, but is not limited to, volatile (e.g. random-access memory (RAM)), non-volatile (e.g. read-only memory (ROM)), flash memory, or any combination. System memory 1104 may include operating system 1105, one or more programming modules 1106, and may include a program data 1107. Operating system 1105, for example, may be suitable for controlling computing device 1100's operation. In one embodiment, programming modules 1106 may include image-processing module, machine learning module. Furthermore, embodiments of the disclosure may be practiced in conjunction with a graphics library, other operating systems, or any other application program and is not limited to any particular application or system. This basic configuration is illustrated in FIG. 11 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated in FIG. 11 by a removable storage 1109 and a non-removable storage 1110. Computer storage media may include volatile and non-volatile, removable and non-removable media implemented in any method or technology for storage of information, such as computer-readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, a location sensor, a camera, a biometric sensor, etc. Output device(s) 1114 such as a display, speakers, a printer, etc. may also be included. The aforementioned devices are examples and others may be used.

Computing device 1100 may also contain a communication connection 1116 that may allow device 1100 to communicate with other computing devices 1118, such as over a network in a distributed computing environment, for example, an intranet or the Internet. Communication connection 1116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1104, including operating system 1105. While executing on processing unit 1102, programming modules 1106 (e.g., application 1120 such as a media player) may perform processes including, for example, one or more stages of methods, algorithms, systems, applications, servers, databases as described above. The aforementioned process is an example, and processing unit 1102 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method for recommending gift cards for maximizing rewards on purchasing products using the gift cards, the method comprising:
receiving, using a communication device, a purchase request from at least one user device associated with at least one user, wherein the purchase request comprises a product data associated with at least one product;
identifying, using the processing device, at least one merchant from a plurality of merchants based on the purchase request, wherein the at least one merchant sells the at least one product;
identifying, using the processing device, at least one store associated with the at least one merchant based on the identifying of the at least one merchant, wherein the at least one store provides a plurality of gift cards for purchasing the at least one product from the at least one merchant;
receiving, using the communication device, a plurality of gift card data associated with the plurality of gift cards from at least one store device associated with the at least one store, wherein the plurality of gift card data comprises a plurality of rewards available to the at least one user corresponding to a plurality of criteria for availing the plurality of rewards;
analyzing, using the processing device, the plurality of gift card data using at least one machine learning model;
identifying, using the processing device, at least one gift card from the plurality of gift cards based on the analyzing of the plurality of gift card data, wherein a value of at least one reward associated with the at least one gift card is maximum in relation to the plurality of rewards associated with the plurality of gift cards corresponding to at least one criterion of the plurality of criteria for availing the at least one reward;
generating, using the processing device, at least one recommendation for the plurality of gift cards is based on the identifying of the at least one gift card;
transmitting, using the communication device, the at least one recommendation to the at least one user device; and
storing, using a storage device, the at least one recommendation.

2. The method of claim 1 further comprises:
receiving, using the communication device, a user data from the at least one user device, wherein the user data comprises at least one user constraint;
analyzing, using the processing device, the user data using the at least one machine learning model;
determining, using the processing device, a fullfilment of each of the plurality of criteria by the at least one user constraint based on the analyzing of the user data and the analyzing of the plurality of gift card data; and
identifying, using the processing device, the at least one criterion ideal to the at least one user based on the determining of the fulfillment, wherein the identifying of the at least one gift card is further based on the identifying of the at least one criterion.

3. The method of claim 2, wherein the user data comprises a location data associated with the at least one user, wherein the location data comprises a location of the at least one user, wherein the at least one user constraint comprises the location, wherein the plurality of criteria comprises one or more geographical location restrictions, wherein the analyzing of the user data comprises analyzing the location data using the at least one machine learning model, wherein the fulfillment comprises a location fulfillment, wherein the determining of the fulfillment comprises determining the location fulfillment of each of the one or more geographical location restrictions by the location, wherein the identifying of the at least one criterion ideal to the at least one user is further based on the determining of the location fulfillment.

4. The method of claim 3, wherein the at least one user device comprises at least one sensor, wherein the at least one sensor is configured for generating the location data based on detecting the location of the at least one user, wherein the user data comprises the location data.

5. The method of claim 2, wherein the user data comprises a user preference data associated with the at least one user, wherein the user preference data comprises at least one preference of the at least one user associated with the plurality of rewards, wherein the at least one user constraint comprises the at least one preference, wherein the analyzing of the user data comprises analyzing the user preference data using the at least one machine learning model, wherein the fulfillment comprises a preference fulfillment, wherein the determining of the fulfillment comprises determining of the preference fulfillment of each of the plurality of requirements by the at least one preference, wherein the identifying of the at least one criterion ideal to the at least one user is further based on the determining of the preference fulfillment.

6. The method of claim 2, wherein the user data comprises a user payment data associated with the at least one user, wherein the user payment data comprises at least one payment option of the at least one user, wherein the at least one user constraint comprises the at least one payment option, wherein the analyzing of the user data comprises analyzing the user payment data using the at least one machine learning model, wherein the fulfillment comprises a payment option fulfillment, wherein the determining of the fulfillment comprises determining the payment option fulfillment of each of the plurality of criteria by the at least one payment option, wherein the identifying of the at least one criterion ideal to the at least one user is further based on the determining of the payment option fulfillment.

7. The method of claim 6, wherein the at least one user device comprises at least one input device, wherein the at least one input device is configured for generating the at least one input data based on scanning at least one physical payment card associated with the at least one user, wherein the user payment data comprises the at least one input data, wherein the at least one payment option comprises the at least one physical payment card.

8. The method of claim 1 further comprising determining, using the processing device, a compatibility between two or more of the plurality of criteria for the availing of two or more of the plurality of rewards associated with the two or more of the plurality of gift cards, wherein the at least one gift card comprises two or more gift cards, wherein the identifying of the at least one gift card comprises identifying the two or more gift cards based on the determining of the compatibility, wherein the value of the two or more of the plurality of rewards associated with the two or more gift cards is maximum in relation to the plurality of rewards associated with the plurality of gift cards corresponding to the compatibility between two or more of the plurality of criteria, wherein the generating of the at least one recommendation for the gift cards is further based on the identifying of the at one or more gift cards.

9. The method of claim 1 further comprising:
generating, using the processing device, a buy order for the purchasing of the at least one product based on the identifying of the at least one gift card;
transmitting, using the communication device, the buy order to at least one merchant device associated with the at least one merchant;
receiving, using the communication device, a confirmation corresponding to the buy order from the at least one merchant device; and
transmitting, using the communication device, the confirmation to the at least one user device.

10. The method of claim 9 further comprising storing, using the storage device, at least one of the confirmation, the buy order, and the purchase request in a distributed ledger.

11. A system for recommending gift cards for maximizing rewards on purchasing products using the gift cards, the system comprising:
a communication device configured for:
receiving a purchase request from at least one user device associated with at least one user, wherein the purchase request comprises a product data associated with at least one product;
receiving a plurality of gift card data associated with a plurality of gift cards from at least one store device associated with at least one store, wherein the plurality of gift card data comprises a plurality of rewards available to the at least one user corresponding to a plurality of criteria for availing the plurality of rewards; and
transmitting at least one recommendation to the at least one user device;
a processing device communicatively coupled with the communication device, wherein the processing device is configured for:
identifying at least one merchant from a plurality of merchants based on the purchase request, wherein the at least one merchant sells the at least one product;
identifying the at least one store associated with the at least one merchant based on the identifying of the at least one merchant, wherein the at least one store provides the plurality of gift cards for purchasing the at least one product from the at least one merchant;
analyzing the plurality of gift card data using at least one machine learning model;
identifying at least one gift card from the plurality of gift cards based on the analyzing of the plurality of gift card data, wherein a value of at least one reward associated with the at least one gift card is maximum in relation to the plurality of rewards associated with the plurality of gift cards corresponding to at least one criterion of the plurality of criteria for availing the at least one reward; and
generating the at least one recommendation for the plurality of gift cards based on the identifying of the at least one gift card; and
a storage device communicatively coupled with the communication device, wherein the storage device is configured for configured for storing the at least one recommendation.

12. The system of claim 11, wherein the communication device is further configured for receiving a user data from the at least one user device, wherein the user data comprises at least one user constraint, wherein the processing device is further configured for:
analyzing the user data using the at least one machine learning model;
determining a fulfillment of each of the plurality of criteria by the at least one user constraint based on the analyzing of the user data and the analyzing of the plurality of gift card data; and
identifying the at least one criterion ideal to the at least one user based on the determining of the fulfillment, wherein the identifying of the at least one gift card f is further based on the identifying of the at least one criterion.

13. The system of claim 12, wherein the user data comprises a location data associated with the at least one user, wherein the location data comprises a location of the at least one user, wherein the at least one user constraint comprises the location, wherein the plurality of criteria comprises one or more geographical location restrictions, wherein the analyzing of the user data comprises analyzing the location data using the at least one machine learning model, wherein the fulfillment comprises a location fulfillment, wherein the determining of the fulfillment comprises determining the location fulfillment of each of the one or more geographical location restrictions by the location, wherein the identifying of the at least one criterion ideal to the at least one user is further based on the determining of the location fulfillment.

14. The system of claim 13, wherein the at least one user device comprises at least one sensor, wherein the at least one sensor is configured for generating the location data based on detecting the location of the at least one user, wherein the user data comprises the location data.

15. The system of claim 12, wherein the user data comprises a user preference data associated with the at least one user, wherein the user preference data comprises at least one preference of the at least one user associated with the plurality of rewards, wherein the at least one user constraint comprises the at least one preference, wherein the analyzing of the user data comprises analyzing the user preference data using the at least one machine learning model, wherein the fulfillment comprises a preference fulfillment, wherein the determining of the fulfillment comprises determining of the preference fulfillment of each of the plurality of requirements by the at least one preference, wherein the identifying of the at least one criterion ideal to the at least one user is further based on the determining of the preference fulfillment.

16. The system of claim 12, wherein the user data comprises a user payment data associated with the at least one user, wherein the user payment data comprises at least one payment option of the at least one user, wherein the at least one user constraint comprises the at least one payment option, wherein the analyzing of the user data comprises analyzing the user payment data using the at least one machine learning model, wherein the fulfillment comprises a payment option fulfillment, wherein the determining of the fulfillment comprises determining the payment option fulfillment of each of the plurality of criteria by the at least one payment option, wherein the identifying of the at least one criterion ideal to the at least one user is further based on the determining of the payment option fulfillment.

17. The system of claim 16, wherein the at least one user device comprises at least one input device, wherein the at least one input device is configured for generating the at least one input data based on scanning at least one physical payment card associated with the at least one user, wherein the user payment data comprises the at least one input data, wherein the at least one payment option comprises the at least one physical payment card.

18. The system of claim 11, wherein the processing device is further configured for determining a compatibility between two or more of the plurality of criteria for the availing of two or more of the plurality of rewards associated with the two or more of the plurality of gift cards, wherein the at least one gift card comprises two or more gift cards, wherein the identifying of the at least one gift card comprises identifying the two or more gift cards based on the determining of the compatibility, wherein the value of the two or more of the plurality of rewards associated with the two or more gift cards is maximum in relation to the plurality of rewards associated with the plurality of gift cards corresponding to the compatibility between two or more of the plurality of criteria, wherein the generating of the at least one recommendation for the gift cards is further based on the identifying of the at one or more gift cards.

19. The system of claim 11, wherein the processing device is further configured for generating a buy order for the purchasing of the at least one product based on the identifying of the at least one gift card, wherein the communication device is further configured for:
transmitting the buy order to at least one merchant device associated with the at least one merchant:
receiving a confirmation corresponding to the buy order from the at least one merchant device; and
transmitting the confirmation to the at least one user device.

20. The system of claim 19, wherein the storage device is further configured for storing at least one of the confirmation, the buy order, and the purchase request in a distributed ledger.
